(19) United States
(12) Patent Application Publication
(10) Pub. No.: US 2003/0061616 A1
(43) Pub. Date: Mar. 27, 2003

(54) Re-broadcasting systems and methods using automatic gain control

(76) Inventors: Georgios Kokovidis, Waltham, MA (US); Sergio Parise, Westford, MA (US)

Correspondence Address: LUCASH, GESMER & UPDEGROVE, LLP, 40 BROAD ST, SUITE 300, BOSTON, MA, 02109, US

(21) Appl. No.: 09/957,865

(22) Filed: Sep. 21, 2001

(51) Int. Cl. H04N 7/18; H04N 7/16

(52) U.S. Cl. 725/78; 725/74; 725/148

(57) ABSTRACT

A system for self-contained, low-power re-broadcast and reception of content signals at least contains a content signal transmitter adapted to transmit/re-broadcast a content signal which it has Frequency Modulated (FM), at least includes one receiver adapted to receive the FM content signal, a cable infrastructure with cables adapted for transmitting in-building content signals, and an antenna connected to a cable and placed in the effective range of the receiver, given predefined maximum antenna power limits (such as those defined by the Federal Communications Commission). Consequently, receivers which do not have (or have available) coaxial cable jacks, or those which do have coaxial cable jacks but are not physically reachable by coaxial can still receive re-broadcast content signals. In the preferred embodiment, an automatic gain control (AGC) circuit is connected between the cable and the antenna to maintain the signal transmitted power level close to the allowable maximum, while not exceeding it.

### BACKGROUND OF THE INVENTION

1. Field of the Invention

The present invention generally relates to improvements in low-power, re-broadcasting systems, and in particular, relates to such improvements adapted for use in connection with home networks such as those described in commonly owned U.S. patent application Ser. No. 09/365,726, entitled “Multi-Service In-Home Network With an Open Interface” (Attorney Docket: UCN-002), incorporated by reference herein.

2. Background

Low-power re-broadcasting systems are used to re-transmit a content signal from a first device or receiver to another (legacy device), either to allow the content signal to be reproduced by a more desirable transducer than is embodied in the first device/receiver, or to extend the effective range of the first device/receiver. An example of the first type of low-power re-broadcasting system is one that includes a device such as a portable compact disc (CD) with limited aural reproduction capabilities (e.g., headphones or earplugs) having an adapter which rebroadcasts the content signal from a CD to a nearby frequency-modulated (FM) receiver over an unused channel (frequency). The receiver is connected to amplified loudspeakers that have a better reproduction quality for listeners.

An example of the second type of low-power re-broadcasting system uses an infrared (IR) transmitter or a radio frequency (RF) transmitter coupled to an antenna for re-broadcasting inside of a building, either to a nearby IR receiver (when the transmitter is of the IR variety) or to a nearby FM receiver.

In many countries there are broadcast regulations limiting the amount of radiation power in the re-broadcast signal so as not to interfere with other communications. For example, at the time of filing of the application for this Letters Patent, the Federal Communications Commission (FCC) required that re-broadcast signals in such a signal have a radiation power of no more than 250 microvolts per meter measured at a distance of 3 meters from the re-broadcast antenna. As a result, the effective range of a communication link established in such a system is rather small (approximately 30 feet or 9.14 meters) under average conditions.

There are other in-building re-broadcast systems which avoid the use of antennae and thus extend the effective range of the re-transmitter by connecting the re-transmitter to the receiver via wiring such as 75-ohm coaxial cable. However, only devices having a special jack for such cable can receive the re-broadcast content signal. Some receivers which would otherwise suffice do not have the requisite cable jack. Others which contain the type of cable jack required may already be utilizing said cable jack to receive other information for another unrelated purpose. Still others which have compatible jacks may not be physically located close enough to be connected to the cable.

What is desirable but not addressed by the prior art is a low-power re-broadcast system having the extended range of the coaxial cable variety, but the convenience and stop-gap advantages of the antenna variety where cable connections cannot or cannot be feasibly made between the re-transmitter and the receivers. It is also desirable to maintain the effective radiation power of the re-broadcast content signal as close to the maximum allowable level as possible, while not exceeding it.

### SUMMARY OF THE INVENTION

In view of the aforementioned problems and deficiencies of the prior art, the present invention provides, a system for self-contained, low-power broadcast and reception of content signals. The system at least includes a content signal transmitter adapted to transmit a content signal, a receiver adapted to receive a content signal, an antenna placed within a predetermined effective range of the receiver, the range related to a predetermined low-power transmission standard requirement, and the antenna adapted to wirelessly rebroadcast a received content signal to the receiver, and a cable infrastructure at least including a plurality of cables, the cable infrastructure at least partially subsumed by the walls of a building structure, and the cables at least adapted for in-building transmission and reception of content signals. The cable infrastructure couples the content signal transmitter to the antenna and provides the communication link between the content signal transmitter and the antenna.

The present invention also provides a method of self-contained, low-power broadcast and reception of content signals. The method at least includes the steps of, via a content signal transmitter, transmitting a content signal, via at least one receiver, receiving a content signal, placing at least one antenna within a predetermined effective range of the receiver, the range related to a predetermined low-power transmission standard requirement, and via the antenna, wirelessly re-broadcasting a received content signal to the receiver. The method further includes the steps of providing a cable infrastructure at least including a plurality of cables, the cable infrastructure at least partially subsumed by the walls of a building structure, and the cables at least adapted for in-building transmission and reception of content signals, and coupling the content signal transmitter to the antenna via the cable infrastructure so that the cable infrastructure provides the communication link between the content signal transmitter and the antenna.

### BRIEF DESCRIPTION OF THE DRAWINGS

Features and advantages of the present invention will become apparent to those skilled in the art from the description below, with reference to the following drawing figures, in which:

FIG. 1 is a schematic block diagram of the present-inventive low-power re-broadcasting system;

FIG. 2 is a schematic block diagram of the home server/content signal transmitter of the system in FIG. 1; and

FIG. 3 is a schematic block diagram of the automatic gain control circuits of the system in FIG. 1.

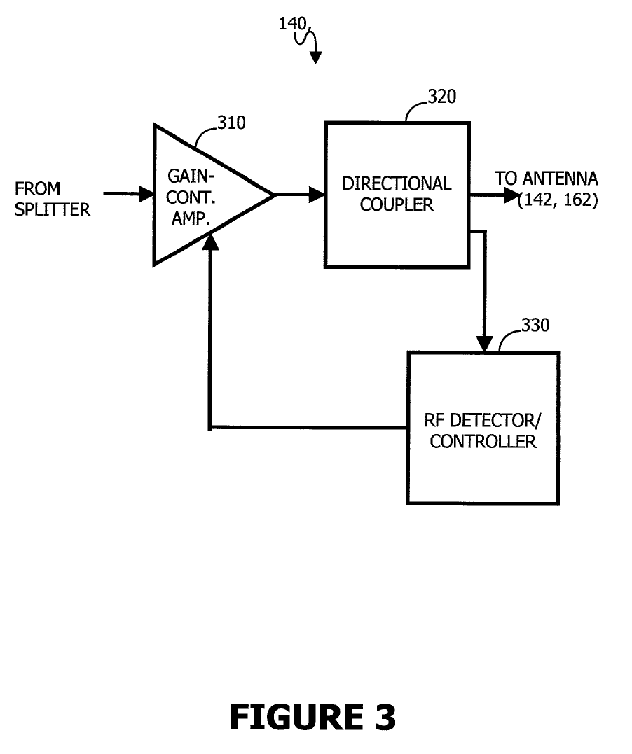

### DETAILED DESCRIPTION OF THE INVENTION

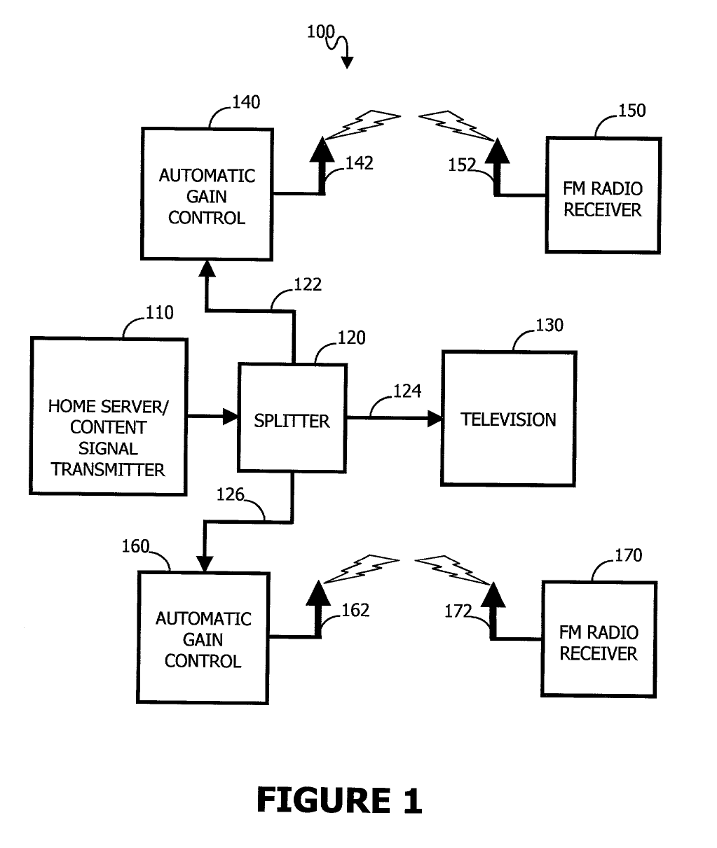

To solve the problems of the prior art described supra, the present-inventive low-power re-broadcasting system 100, generally illustrated in FIG. 1, connects a home server 110, responsible for re-transmitting a content signal, to automatic gain control (AGC) circuits 140 and 160 via coaxial cables 122 and 126. The AGC circuits 140 and 160 are connected to antennae 142 and 162, which antennae transmit low-power FM content signals to nearby legacy devices 150 and 170. The AGC circuits 140 and 160 maintain the content signal radiated from the antennae 142 and 162 at the maximum allowable regulatory power level without exceeding said power level.

When the system 100 is a residential one, the home server (also designated as a “content signal transmitter” for purposes of the present invention) 110 can be placed at a convenient location such as in a basement or closet. The home server 110 receives content signals via a coaxial cable, satellite dish or other means well known in the art. In the preferred embodiment, the home server outputs video and audio content signals to a splitter 120 responsible for directing signals through separate jacks to different devices. The splitter 120 directs the television signal to one or more televisions 130 on the premises, and directs the FM audio signals to the re-broadcast antennae for low power re-broadcast. In an alternate embodiment, the housing of the home server can subsume the functions carried out by the splitter 120.

In an example, the home server 110 may receive content signals such as television signals (whether digital or audio) and digital audio signals, such as those formatted in the Motion Picture Experts Group, Layer 3 (“MPEG-1, layer 3” or “MP3”) standard from a service provider (such as a cable company). The video and audio portions of the television signal are sent to one or more cable-connected televisions 130 (via coaxial cables such as the one 124) on the premises for reproduction. The home server 110 also decodes other signals such as MP3 signals for distribution throughout the premises. The MP3 signals are decoded, converted to analog signals, and then frequency modulated in a manner known in the art.

The coaxial cables 122 and 126 carry the FM content signals first to the AGC circuits 140 and 160, and then to antennae 142 and 162 for low-power broadcast to FM radio receivers 150 and 170 within the effective range of the antennae. The FM radio receivers 150 and 170 initially receive the content signals via antennae 152 and 172, respectively. As is known in the art, the content signals are broadcast over unused center frequencies, to which the system user tunes the FM radio receivers.

Especially where the coaxial cables 122 and 126 leading to the re-broadcast antennae 140 and 160 are long, the signal strength can be considerably attenuated or degraded due to transmission line losses. Without the AGC circuits, the effective range of the antennae 140 and 160 might be considerably lower than for the case of maximum regulatory signal power. The AGC circuits solve this problem by boosting content signals with less than maximum power levels to said maximum levels, while reliably preventing the signal level from exceeding the maximum level.

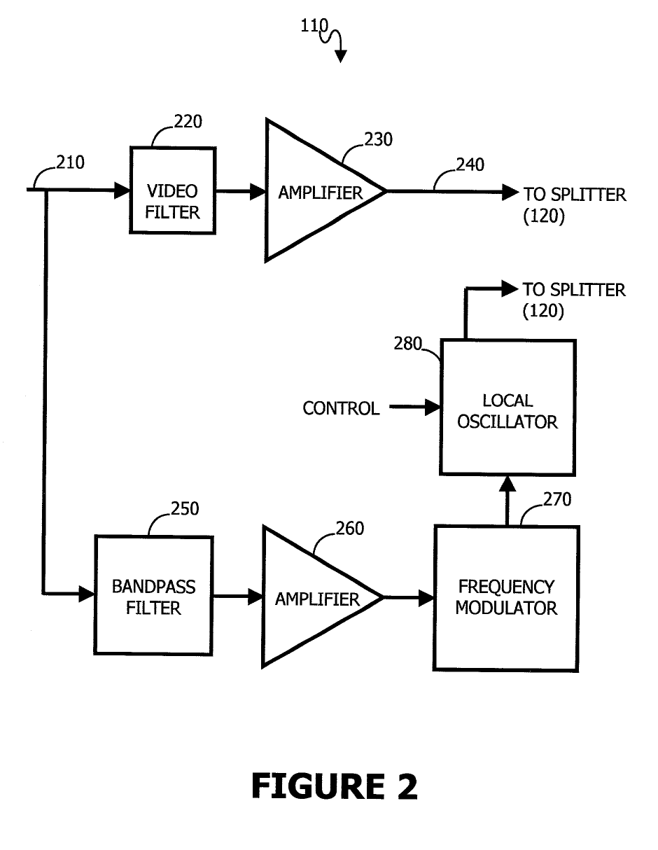

FIG. 2 provides greater detail of the home server/content signal transmitter 110. The input 210 of the home server 110 receives a composite signal that is presented to a video filter 220 and a bandpass filter 250. The video filter allows a television signal to be transmitted through to an amplifier 230 for boosting the signal level of a received television signal. The output 240 of the amplifier 230 is sent to the splitter 120. The bandpass filter 250 passes the audio signal through to an amplifier 260. If the audio signal is in digital form, the home server 110 uses a digital-to-analog converter (not shown) to convert the audio signal to an analog form. A frequency modulator 270 then frequency modulates a local oscillator 280 to produce an FM audio signal for presentation to the splitter 120.

Each AGC circuit 140 and 160 nominally includes a gain-controlled amplifier 310 with its output connected to a directional coupler 320, and a closed feedback loop between the directional coupler, in which the feedback loop includes an RF Detector/Controller 330. While one output of the directional coupler 320 is connected to the feedback loop, the other output is connected to the associated re-broadcast antenna 142 or 162. An integrated circuit (IC) chip in the preferred embodiment, the RF Detector/Controller 330 monitors the signal power level from the directional coupler and adjusts the gain of the amplifier accordingly to maintain the power level at the maximum allowable level without surpassing it.

Variations and modifications of the present invention are possible, given the above description. However, all variations and modifications which are obvious to those skilled in the art to which the present invention pertains are considered to be within the scope of the protection granted by this Letters Patent.

What is claimed is:

1. A system for self-contained, low-power broadcast and reception of content signals, said system comprising:
a content signal transmitter adapted to transmit a content signal;
at least one receiver adapted to receive a content signal;
at least one antenna placed within a predetermined effective range of said receiver, said range related to a predetermined low-power transmission standard requirement, and said antenna adapted to wirelessly rebroadcast a received content signal to said receiver; and
a cable infrastructure comprising a plurality of cables, said cable infrastructure at least partially subsumed by the walls of a building structure, and said cables at least adapted for in-building transmission and reception of content signals;
wherein said cable infrastructure couples said content signal transmitter to said antenna and provides the communication link between said content signal transmitter and said antenna.

2. The system in claim 1, further comprising:
an automatic gain control (AGC) circuit coupled between said cable infrastructure and said antenna, said AGC circuit adapted to regulate the gain of said antenna substantially at said predetermined low-power transmission standard requirement.

3. The system in claim 1 wherein said low-power transmission standard requirement is a limitation of 250 microvolts per meter at a distance of 3 meters.

4. The system in claim 2 wherein said low-power transmission standard requirement is a limitation of 250 microvolts per meter at a distance of 3 meters.

5. The system in claim 1 wherein said content signal is a frequency-modulated (FM) signal with a center frequency substantially unused by a commercial broadcast station at the location of said receiver.

6. The system in claim 2 wherein said content signal is a frequency-modulated (FM) signal with a center frequency substantially unused by a commercial broadcast station at the location of said receiver.

7. The system in claim 1 wherein said content signal transmitter is subsumed by a server adapted to receive and re-broadcast within said system, a commercially available information signal, said information signal subsuming said content signal.

8. The system in claim 2 wherein said content signal transmitter is subsumed by a server adapted to receive and re-broadcast within said system, a commercially available information signal, said information signal subsuming said content signal.

9. The system in claim 7, wherein said content signal is an FM audio signal, and said system further comprises a splitter coupled to said server, said splitter at least being adapted to separate from said information signal, said FM audio signal, and a video signal.

10. The system in claim 8, wherein said content signal is an FM audio signal, and said system further comprises a splitter coupled to said server, said splitter at least being adapted to separate from said information signal, said FM audio signal, and a video signal.

11. A method of self-contained, low-power broadcast and reception of content signals, said method comprising the steps of:
via a content signal transmitter, transmitting a content signal;
via at least one receiver, receiving a content signal;
placing at least one antenna within a predetermined effective range of said receiver, said range related to a predetermined low-power transmission standard requirement;
via said antenna, wirelessly re-broadcasting a received content signal to said receiver;
providing a cable infrastructure comprising a plurality of cables, said cable infrastructure at least partially subsumed by the walls of a building structure, and said cables at least adapted for in-building transmission and reception of content signals; and
coupling said content signal transmitter to said antenna via said cable infrastructure so that said cable infrastructure provides the communication link between said content signal transmitter and said antenna.

12. The method in claim 11, further comprising the step of:
via an automatic gain control (AGC) circuit coupled between said cable infrastructure and said antenna, regulating the gain of said antenna substantially at said predetermined low-power transmission standard requirement.

13. The method in claim 11 wherein said low-power transmission standard requirement is a limitation of 250 microvolts per meter at a distance of 3 meters.

14. The method in claim 12 wherein said low-power transmission standard requirement is a limitation of 250 microvolts per meter at a distance of 3 meters.

15. The method in claim 11 wherein said content signal is a frequency-modulated (FM) signal with a center frequency substantially unused by a commercial broadcast station at the location of said receiver.

16. The method in claim 12 wherein said content signal is a frequency-modulated (FM) signal with a center frequency substantially unused by a commercial broadcast station at the location of said receiver.

17. The method in claim 11 wherein said content signal transmitter is subsumed by a server, and said method further comprises the step of, via said server, receiving and re-broadcasting a commercially available information signal, said information signal subsuming said content signal.

18. The method in claim 12 wherein said content signal transmitter is subsumed by a server, and said method further comprises the step of, via said server, receiving and re-broadcasting a commercially available information signal, said information signal subsuming said content signal.

19. The method in claim 17, wherein said content signal is an FM audio signal, and said method further comprises the step of, via a splitter coupled to said server, separating from said information signal, said FM audio signal, and a video signal.

20. The method in claim 18, wherein said content signal is an FM audio signal, and said method further comprises the step of, via a splitter coupled to said server, separating from said information signal, said FM audio signal, and a video signal.
